(19) United States
(12) Patent Application Publication
(10) Pub. No.: US 2002/0095355 A1
(43) Pub. Date: Jul. 18, 2002

(54) Computer-implemented international trade system

(75) Inventors: David Walker, Norwood, NJ (US); Marc Lisketing, Eslohe (DE); Stephan Kneipp, Wendish Evern (DE)

Correspondence Address: CASELLA & HESPOS, 274 MADISON AVENUE, NEW YORK, NY, 10016

(73) Assignee: Doreen A. Labit, Arlington, TX

(21) Appl. No.: 10/053,066

(22) Filed: Jan. 17, 2002

Related U.S. Application Data
(60) Provisional application No. 60/262,484, filed on Jan. 18, 2001.

(51) Int. Cl. G06F 17/60

(52) U.S. Cl. 705/26

(57) ABSTRACT

The computer-implemented international trade system is the business logic of an expert system which manages, guides and integrates the complete export/import trade process of single cross-border merchandise trade transactions on behalf of a buyer and seller, each accessing the system remotely using personal computers and web browsers. This system is designed to be accessed by users in an application service provider environment, and utilizes a combination of currently existing e-commerce technology, computer server technology, extensible markup language, encryption software, and database software, all integrated and controlled by a unique series of software applications created around the business logic. The object of the invention is to minimize time, costs, risks and required process knowledge, while maximizing the probability of a successful outcome, for cross-border merchandise trade transactions, especially for small to mid-sized firms worldwide.

### CROSS-REFERENCE TO PRIOR APPLICATIONS

This application claims priority of U.S. Provisional application Ser. No. 60/262,484, filed Jan. 18, 2001.

### BACKGROUND OF THE INVENTION

1. Field of the Invention

The subject invention involves a system for performing data processing operations for the cross-border trade process, in which there are significant changes in the data and for which calculation operations are performed wherein the apparatus or method is uniquely designed for or utilized in the process of international merchandise trade, its practice, administration, and management. This system includes the processing of financial data related to an import/export transaction, and also provides for apparatus and corresponding methods for performing data processing and calculating operations in which charges for transaction-related goods and services are determined. These processes are combined with cryptographic apparatus and methods to ensure the security of the trade transactions.

2. Description of-the Prior Art

The process of exporting and importing merchandise, or cross-border trade, is an old process, and in many ways has changed little over the centuries. The traditional entities involved in the trade process are the same: the carrier, the freight agent, the bank, the insurer, the government regulatory agency, the buyer and the seller. This process consists of the following major steps:

STEP 1: A potential buyer and seller become aware of each other's requirements and products, and communicate with each other to determine if there might exist a potential supplier/purchaser relationship.

STEP 2: The buyer requests a quotation from the seller for the seller to supply to the buyer specific merchandise, at a specific time and place, for a specific price.

STEP 3: The seller provides the buyer with a quotation, termed in the trade a “Pro Forma Invoice”, containing the various details of an export/import transaction.

STEP 4: Buyer and seller negotiate the terms of sale, terms of delivery and terms of payment expressed within the pro forma invoice. Upon the agreement of terms by both parties, the buyer issues to the seller a purchase order, sales order, or sales agreement. Upon acceptance of the purchase order by the seller, the physical transaction process begins.

STEP 5: Seller produces or otherwise acquires the merchandise, to the specifications of the buyer, which includes labelling, conformation to government or industry standards, packaging, and various governmental regulatory requirements.

STEP 6: Seller, seller's agent, or buyer's agent, as agreed upon, arranges for movement of the merchandise to the port of embarkation, creates the required commercial and declaratory documentation required, and satisfies all export regulatory requirements of the country of export.

STEP 7: Seller, seller's agent, buyer, or buyer's agent contract with one or more carriers to transport the merchandise to the port of destination. The carrier is responsible for creating and distributing the appropriate transport documentation, as well as for shipping regulations as required by governmental agencies and international standards organizations.

STEP 8: The buyer, or the buyer's agent, enters the merchandise through the customs agency of the destination country, complying with customs and other governmental regulations and requirements, paying all required duties and taxes, and providing all required declarations and documents. The buyer, or buyer's agent, transports the merchandise to the final inland destination.

STEP 9: Payment on the part of the buyer and collection on the part of the seller are finalized.

Historically, key elements of the import/export process which directly affect the probability of success of trade transactions are as follows:

a. Economies of Scale: To ensure a high level of success in international trade requires, traditionally, sufficient resources to acquire the appropriate knowledge of the import/export process, usually export and/or import departments of trained, experienced personnel, and the sales and marketing resources required to obtain and process an international order for goods. Larger firms have the resources and economies of scale necessary to trade successfully, while traditionally, small to mid-sized firms do not. This is the major reason that large companies and corporations account for the majority of international sales, while making up a very small percentage of the number of total importers and exporters. Small to mid-sized enterprises, a category defined by the United States Department of Commerce as firms with 500 or less employees, simply do not have the resources, time, personnel or expertise to trade successfully in global markets.

b. Marketing and Sourcing: International marketing and sourcing methods, which serve to allow potential buyers and sellers to discover each others' products and needs, are traditionally more resource-consuming than for domestic methods. These methods include trade fairs, catalog fairs, advertising in foreign publications, and the use of foreign sales representatives and distributors. In addition to the expertise required to market in a foreign country, linguistic, regulatory and cultural differences represent barriers which require knowledge and resources to overcome.

c. Complexity and Multiplicity of Transaction Components: An import/export transaction is not a linear, sequential chain of events with one task occurring after another has been completed. Rather, an international trade transaction consists of many tasks running in parallel. Each task has a separate timeline and its own cast of participants, some unique and some shared with other tasks. Some of these tasks are critical to the physical success of the transaction (i.e. delivery of the merchandise), some are critical to the financial success of the transaction (e.g. the appropriate computation of total cost or selling price, a secure and trusted method of payment and collection), and some are critical to the regulatory success of the transaction (e.g. customs clearance, export regulations).

d. Required Knowledge of Process and Regulations: Unlike domestic business-to-business transactions, which as a rule do not consist of such a large number of “events”, international transactions are much more complex. This complexity requires adequate knowledge of many important processes on the part of both buyer and seller, such as import and export government regulations, international methods of payment and collection, country and product specific standards, required documentation including certifications and declarations, a working knowledge of how to identify and make use of the various third party international trade service providers, and accurate and timely knowledge about each party for the purpose of minimizing financial risk.

e. Use of Third Party Service Providers: The export/import process frequently requires the use of, and the reliance on, various third party international service providers unique to importing and exporting, or the in-house equivalent human resources. These agents provide services in the areas of freight forwarding, customs entry and clearance of goods, warehousing, air, ocean, courier and motor carriage, cargo and credit risk insurance, credit reporting and rating, product inspection, regulatory support and verification, linguistic translation, company verification, third party escrow, letters of credit, trade acceptance drafts, credit card processing, documentation, country of origin verification, consular verification, export crating and marking, and many other miscellaneous specialty services.

f. Extended Time of Process: International trade transactions are generally not “immediate” transactions. The process usually takes longer than domestic equivalents, requiring more management control, more professional intermediary service providers, and more “process knowledge” regarding timing and the responsibilities of each party. Weeks—even months—may pass with seemingly little being accomplished, yielding to a period of a few days with many deadlines and key dates.

g. Costs and Risk: Import/export transactions generally entail higher costs for both the buyer and seller than their domestic equivalents. They require more resources to manage the process successfully, create and store information and documentation, fulfill regulatory obligations, reduce the risks of non-collection and non-payment, and to provide for adequate quotations. Costs are also greater for professional services like international carriage, product customization, regulatory/standards requirements, service provider/agents fees, payment facilities, insurance, communications, translation and computerization/electronic data processing. Without the addition of the appropriate resources to offset these costs, the process encurs greater risk—risk of regulatory non-compliance, risk of non-delivery, and risk of non-payment and non-collection.

h. The Successful Trade Transaction: An international trade transaction is a set of multiple tasks, or events, requiring in-depth process and country-specific regulatory knowledge and adequate resources to manage the process, carried out over an extended period of time, bearing comparably higher costs and risk than domestic transactions, and which utilize multiple third party service providers unique to cross-border trade. The likelihood of success of such a transaction is directly related to the level of knowledge of the process by the participants, the quality, ability and co-ordination of the service providers, the verification and trust of the parties, the level of resources available to the parties, and the adequacy and timeliness of the preparation and distribution of information and documentation.

Existing problems in the Cross-Border Trade Process: Problems currently experienced by exporters and importers as they process international trade transactions are as follows, and are traditionally more severe for small to mid-sized buyers and sellers:

a. Marketing and Sourcing: Discovery by the seller and buyer—the matching of sellers' products with buyers' needs—tends to be more expensive and requires greater resources and skill than for domestic equivalents. These resources include attendance at trade shows, contracting of foreign sales representatives and foreign distributors, the acquisition of in-house international sales and marketing staff, and the production of product catalogs and brochures printed in the languages of the target markets. The lack of adequate knowledge of how to market goods to, or procure goods from, a company in a foreign country is a barrier to trade, especially for the small to mid-sized business.

b. Cost Identification: Frequently, not all costs are known to either or both of the transaction parties, causing under estimation of these costs. Importers may discover, too late, that the final landed costs per unit are higher than domestic equivalents, eroding or erasing profit margins. Exporters may find that the prices they have quoted to buyers are lower than anticipated, or even insufficient to cover actual costs. Prevalent in the process are poorly constructed quotations, termed pro forma invoices in international trade, which do not contain all pertinent costs, or which do not define the transaction process adequately, or which do not define which party to the transaction is responsible for specific costs.

c. Defined Responsibilities: Responsibilities for many required activities related to the transaction are not clearly defined between the two parties, or are not known by them, causing unnecessary delay or expense.

d. Regulatory Requirements: Either, or both, parties may be unaware of government regulatory requirements, such as specific documentation and declarations, quota requirements, product marking requirements, or procedural requirements, or they may not know how to satisfy these requirements, causing possible delayed deliveries, penalties and fines.

e. Knowledge of the Import/Export Process: Either, or both, parties may be unaware of key process knowledge, such as product marking requirements, or best mode of shipment, or how to procure cargo insurance, or which documents to prepare, causing wasted time, increased costs and delayed shipments and deliveries.

f. Verification of Parties: Due to inadequate verification of the parties to each other, or because of inadequate credit or financial knowledge of a party, payment and collection methods tend to be riskier and more costly.

g. Process Management: The control and management of the process, and the information generated and required by the process, including the management and coordination of the various third party service providers, are time consuming and difficult chores. The resources required to ensure a successful trade transaction are expensive, especially for small to mid-sized firms. These resources include electronic data processing applications designed to assist buyers and sellers in their processing of various transaction elements, the attendant computer equipment and operating systems required to utilize these applications and the management, maintenance and knowledge of the technology used by these applications.

h. International Communications: International communication costs for courier services, telephone and fax are higher than for domestic transactions, creating a burden for small to mid-sized firms. Language and cultural differences may also serve to make international communications difficult, time consuming and ineffective.

i. Information Management: Incorrect and inadequate information management and documentation frequently causes delays in shipments, delivery and the collection of proceeds, and is a large cause for regulatory delays and fines. Inadequate storage, and access to stored information, creates difficulties when such information is required at another stage of the transaction, or for another transaction, or for subsequent financial and regulatory audits.

4. Current State of the Art: Traditionally, the export/import process utilizes paper-based documents for information distribution and storage. Multiple third party service providers are managed and coordinated by the parties themselves, while management and control of the transaction process and regulatory responsibilities are conducted in-house. Third party agents are employed for international marketing and sourcing, while air couriers, postal services, long distance telephone service and facsimile technology are utilized to distribute information. In addition, more expensive methods of payment and collection such as letters of credit are used. The traditional process is document-based, requiring paper documentation to evidence various elements of the transaction, from quotation to the transfer of ownership to the collection of proceeds. It is the scenario still prevalent today for small to mid-sized firms engaged in trade.

Recent computer and software technology now offers exporters and importers various software applications, operable by each party separately, which include logistics, word processing, financial spread sheets, and order/customer management programs. These applications assist international traders in preparing and processing documentation, computing costs and prices, creating product specifications, accessing databases of regulations and process knowledge, order creation and tracking, and controlling internal process flows. These applications, however, still require a high level of expert knowledge of the export/import process, are not generally integrated with third party service providers, are not integrated between the trading parties, and are costly to acquire, maintain and operate.

The advent of the Internet has served to level the playing field in international trade for large and small firms in four major areas. First, regarding international marketing, any firm with a personal computer, web browser and internet access may be successful in locating potential trading partners in various trade portals and on-line trade exchanges, by searching on-line member directories, visiting on-line virtual trade shows, and placing/responding to e-mailed trade opportunities. Second, regarding the communication of trade-related information and documents, e-mail has reduced the costs tremendously for all involved in trade. Third, information regarding trade process expertise, marketing data, and regulatory requirements abounds on the Internet. Fourth, many third party service providers may be accessed from the Internet for information and communications. However, use of the Internet still leaves serious problems for the importers and exporters who utilize it. Trade marketplaces and on-line market exchanges do not facilitate trade transactions between buyers and sellers in different countries. Once firms find their potential partners and decide to trade, they must return to the traditional process to consumate the transaction. While trade information abounds on the Internet, finding the required information is time consuming and requires knowledge of where, and how, to acquire it. Finally, the Internet does not allow for the integration of the parties or the third party service providers, nor does it offer management of the trade process.

A few firms have combined current technology applications with Internet communications and interfaces to process international transactions. They purport to facilitate transactions by creating electronic trade documentation, tracking transactional elements, providing process expertise and regulatory information, and verifying the parties to the trade. A few have integrated third party service providers into their systems. These systems are currently used by larger firms, and may require integrated linkages to their clients' computer systems, as well as software application and database downloads and maintenance. These systems do not encompass the entire export/import process. They are not complete transaction management systems that guide their users through the trade process. These systems require expert process knowledge to use and they are not fully integrated with all the required third party service providers. These systems are not designed to be open to all exporters and importers on a transaction basis and therefore, users must become members, be credit checked, and pay membership and licensing fees. As such, their user bases are relatively small, and comprise larger firms.

To overcome the deficiencies of the prior art, it is an object of the subject invention to provide an import/export solution for importers and exporters, primarily for small to mid-sized firms.

It is a further object of the subject invention to provide a method that requires no initial outlay for computer hardware or software.

It is yet another object of the subject invention to provide an integrated transaction system covering all phases of the import/export transaction.

It is another object of the subject invention to provide a system that is not restricted to a closed network, but is accessible by all importers and exporters.

It is a further object of the subject invention to integrate necessary third-party providers seamlessly into the transaction process.

Another object of the subject invention is to archive transaction records for repeat users to use in future transactions.

Yet another object of the subject invention is to provide a system that manages and guides buyers and sellers through the entire transaction process.

### SUMMARY OF THE INVENTION

1. General Overview of the Invention: The invention operates with, and depends upon, the use of current e-commerce technology and the Internet as the communication medium, personal computers, commercial web browsers, commercial operating systems and commercial software applications such as e-mail programs, portable document viewing applications, word processing programs, spread sheet applications, and visual presentation viewing programs. The subject invention, that will be commercially named the Global Trade InterNetwork (“GTI System”), creates a controlled, guided, secure electronic commercial environment for the processing of an import/export transaction between a buyer and seller. This environment is produced by a business process data-processing engine termed the Master Transaction Logic (“MTL”) and exists on a single cluster of computer servers accessible by buyers and sellers over the Internet through interfaces to various host computer servers. It is accessed and used by individuals operating personal computers and web browser programs which can connect to host computer servers. The invention serves to minimize the costs, time and risks of conducting an import/export merchandise transaction, while maximizing the probability of a successful transaction whereby buyers receive delivery of the merchandise ordered and sellers receive payment for merchandise shipped.

The invention is based on a data processing system of software applications, the MTL, that guides both the buyer and seller through the complete import/export process from the point of discovery of the importer and the exporter to each other, either by traditional means or through their usage of host entities, to the delivery of the merchandise and payment, without the requirement of either party to purchase, install or maintain any data processing software applications on their personal computers. The invention accomplishes this process through the interface with specifically contracted third party service providers, integrating their services into the buyer/seller transactions.

2. Three Major Stages of the Invention: The invention manages the export/import transaction process in three major sequential stages:

Stage One—Request for Quotation: The first stage begins with the introduction of the buyer and seller into the system, through interfaces with the a host marketplace, after they have discovered each other within the host's marketplace environment. A private, unique electronic meeting room is created for the parties at this stage, and the system facilitates the issuance of a request for quotation.

Stage Two—Pro Forma Invoice: The second stage of the process creates a unique private electronic trading room, and creates a unique transaction template which guides the buyer and seller to mutually create a pro forma invoice, or quotation document, which identifies all cost elements, identifies third party service providers and their specific services to be rendered, identifies regulatory requirements, and facilitates the assignment of specific responsibilities to each party. The resultant pro forma invoice computes gross margins for both parties, and allows for a sub-process of iterative negotiations and changes to the document.

Stage Three—Commercial Invoice: Upon acceptance of the pro forma invoice by the buyer, a purchase order is created for the seller, and the pro forma template is converted to a commercial invoice transaction template, which begins the third stage. In this final transaction template, the system monitors and tracks the movement of the merchandise, the activities of the contracted third party service providers, and creates and/or acquires, stores and distributes all information and documation pertaining to the transaction. At the completion of the transaction, the system stores and archives the information related to the transaction, as well as the entire transaction itself.

3. Advantages of the GTI System: The GTI System offers many advantages to exporters and importers, especially to those classified as small to mid-sized enterprises, by providing solutions to problems these parties currently face while conducting, or attempting to conduct, international merchandise trade transactions.

a. Cost Identification: The GTI System provides for, and prompts buyers and sellers and third party service providers for, the confirmation, entry or transmission of all costs and expenses associated with a trade transaction. These transaction costs are collected and stored in a pro forma invoice template, which may be viewed by both buyer and seller, and which must be completed and agreed to by both parties prior to any physical export activity. The GTI System prohibits a transaction from continuing on to the commercial invoice stage until the buyer has accepted the pro forma invoice, has issued a purchase order to the seller, and the seller has accepted the purchase order. The GTI System saves delays, disputes, underpricing and overpaying caused by unidentified or misidentified costs from ocurring at later stages in the transaction.

b. Defined Responsibilities: During the pro forma invoice guided process, all elements and costs are identified for the buyer and seller, and the responsibilities for these elements and costs are specifically allocated to either the buyer, the seller or a third party service provider. The GTI System saves delays and confusion caused by misunderstandings of responsibilities at later stages in the transaction.

c. Regulatory Requirements: Buyers and Sellers of the GTI System avoid shipment delays and potential government agency fines and penalties by benefiting from the treatment the GTI System gives towards the various government import and export regulations. Through the use of regulatory knowledge built into the business logic of the GTI System, and through the expert knowledge and business skills possessed by third party service providers such as customs brokers and freight forwarders in the natural course of conducting their businesses, each transaction is reviewed in the pro forma stage for compliance and required documentation.

d. Knowledge of Import/Export Process: System-provided process expertise, built into the GTI System, serves to reduce errors of commission and ommision made by both buyers and sellers and saves both management and clerical time. Classification and procedural mishaps are reduced through the use of the MTL business logic and the reliance on, and contracting of, the appropriate knowledge and services of third part professionals. The GTI System avoids discrepancies and disputes regarding transactions by creating key benchmark trade documents, electronically accepted by both parties, including request for quotation, pro forma invoice, sales/purchase order, third party service providers, power of attorney and commercial invoice. It defines, explains and establishes the complete terms of sale of the transaction at the completion of the pro forma stage, adhering to the International Chamber of Commerce's Incoterms 2000, prior to the beginning of the physical transaction, thus serving to minimize or eliminate any contrary expectations by either the buyer or seller at a later point in the transaction.

e. Verification of Parties: The GTI System, through the business logic of the MTL and by utilizing and managing third party service providers, confirms the legal and physical existence of each party to the transaction, and offers buyers and sellers additional opportunities to further verify the other party. These additional third party service provider services include in-country inspection and investigation, credit reports and chamber of commerce verification. A high level of verification and credit review of the parties allows for greater trust, less stringent terms of payment, and easier usage of less costly methods of payment, such as open account terms backed by credit insurance, credit card payment, and the use of trade acceptance drafts.

f. Management of the Process: Transaction costs, required by the buyer and seller to acquire and use the resources necessary to create a reasonable high probabability of success for their trade transaction, are reduced through the use of the GTI System. Buyers and sellers eliminate the need to purchase, update and maintain export/import transaction software applications by paying to use the GTI System on a transactional basis. They reduce the resource requirements associated with managing and controlling the process by allowing the GTI System to manage their trade transactions and the third party service providers, and they save further by not have to hire or contract for individuals with expert knowledge of the process. They save time and financial investment on training, because the GTI System is designed to be easy to use by buyers and sellers, provides a single transaction source, is a guided process with a simple-to-use Graphical User Interface (“GUI”) and abundant help information, and contains searchable databases of export/import country trade information. Buyers and sellers also benefit by using the GTI System because the security and privacy of transactions are conducted within a 100% encrypted environment.

g. International Communications: Buyers and sellers save in communication expenses by using the GTI System provided features of private threaded discussion rooms, private instant chat rooms and e-mail. All communications utilized through the GTI System are saved, and are accessible to the buyers and sellers, in personal electronic file cabinets created for each party for each transaction.

h. Information Management: Buyers and sellers benefit further through the system's control, distribution and storage of all transaction-related information, documentation and communications. The GTI System's MTL business logic allows for automated document preparation of most key documents, and is designed to acquire and store non-system documents from buyers, sellers and third party providers in a portable document file format. The GTI System archives all information, and serves to save buyers and sellers of the GTI System storage and retrieval expenses by providing off-site storage and retrieval services for all information created in transaction process.

### BRIEF DESCRIPTION OF THE DRAWINGS

FIG. 1 is a schematic diagram showing the elements and interconnections of the subject invention.

FIGS. 2A-2L illustrate the process steps of the subject invention.

FIG. 3 is a schematic diagram illustrating the subject invention's system architecture.

### DETAILED DESCRIPTION OF THE PREFERRED EMBODIMENTS

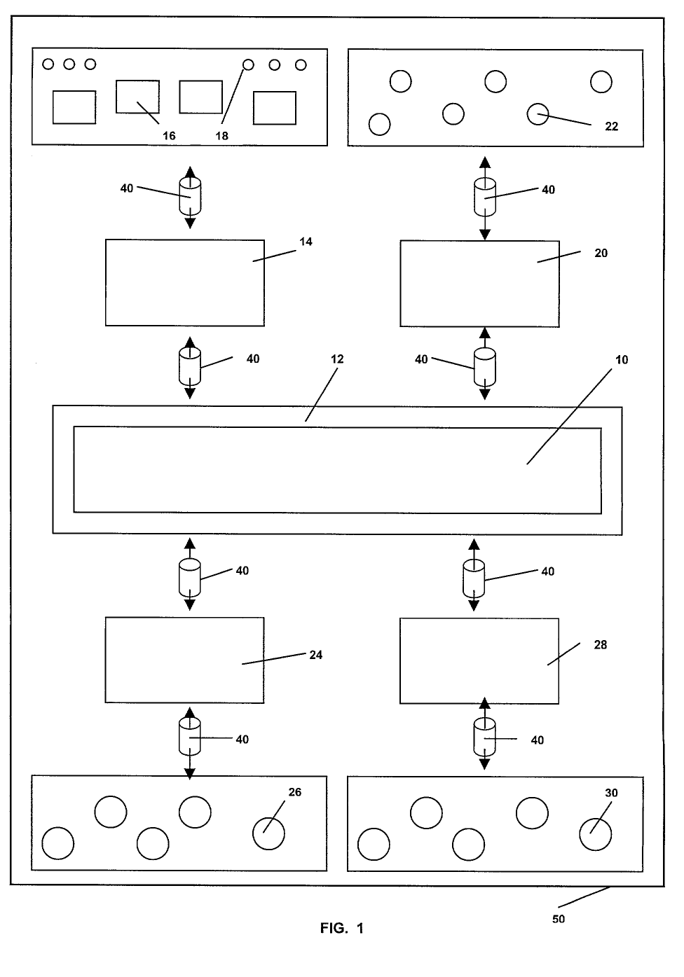

Referring to FIG. 1, the invention, termed the GTI System 50, consists of an integrated group of electronic data processing applications, of which the core business processing engine is termed the MTL 10. These applications serve to guide a buyer and a seller through the various steps which comprise a cross-border export/import transaction of merchandise goods, inserting the expertise and services of contracted third party service providers 28,30 and utilizing internal databases of business rules and trade information. Buyers and sellers, as end-users, access the GTI System 50 through their existing communication channels 40 and by a collection of entities known as “intermediary hosts.” These intermediary hosts consist of marketplace networks 14, marketplace networks client entities 16, trade related industry specific marketmakers 20 and corporate entities 24. Trade related industry specific marketmakers 20 encompass a diverse group including marketplaces, international trade associations, vertical and horizontal trading hubs, and trading exchanges.

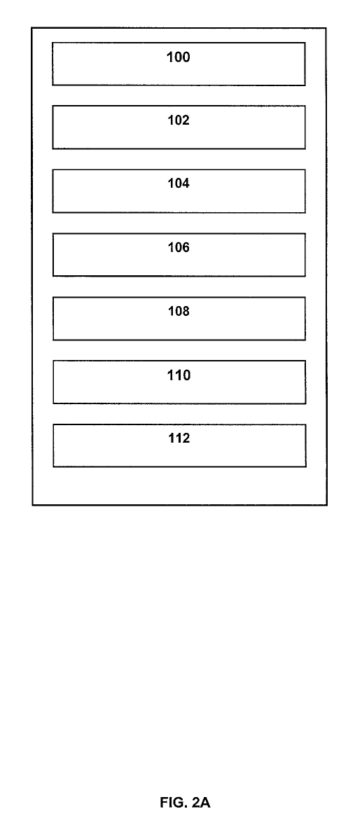

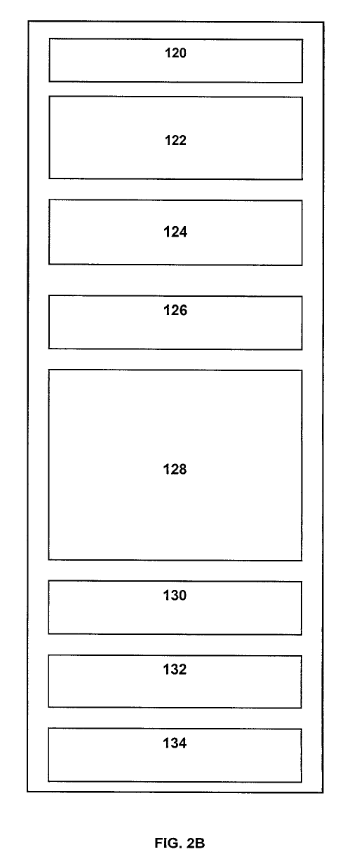

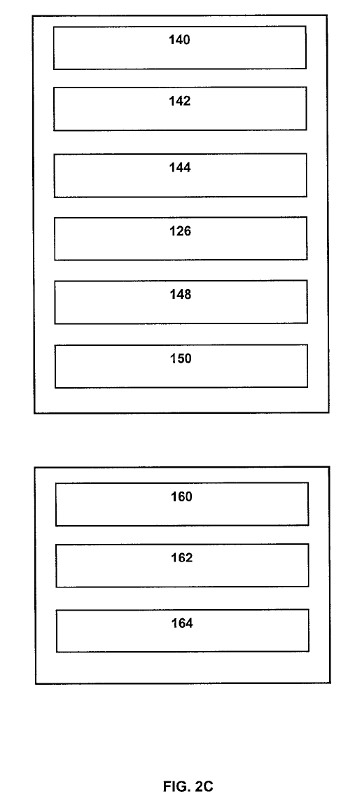

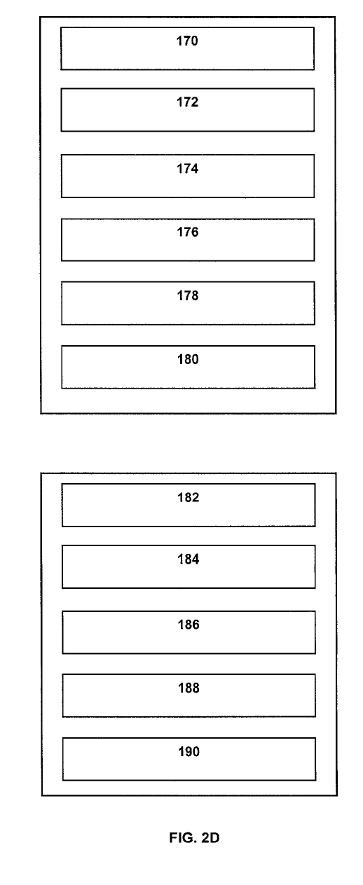

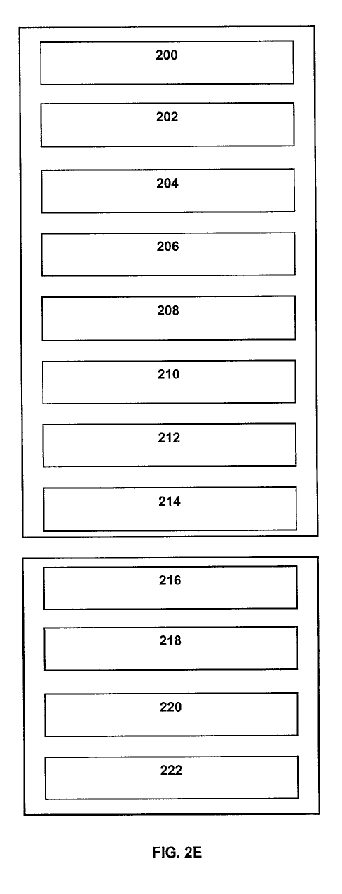

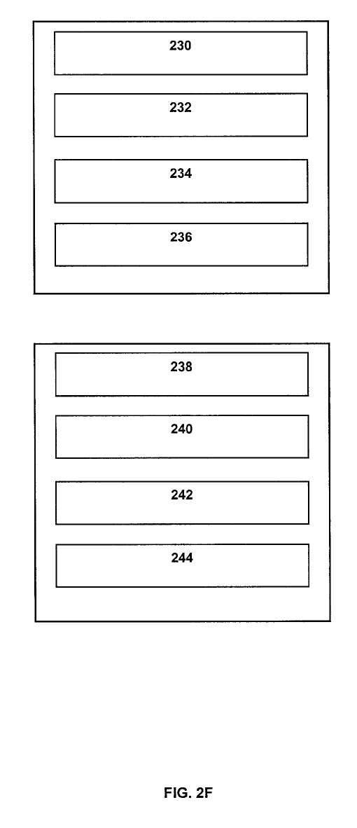

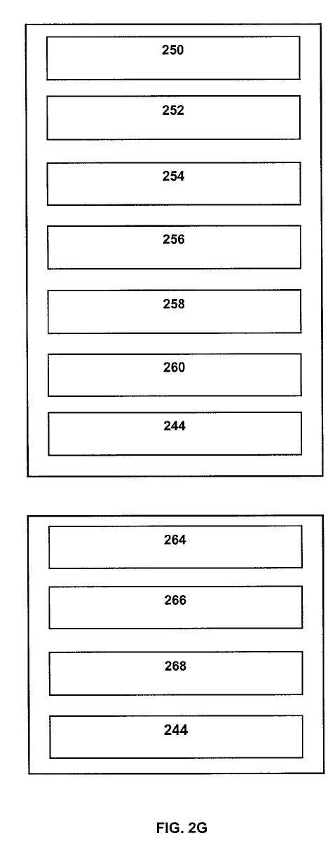

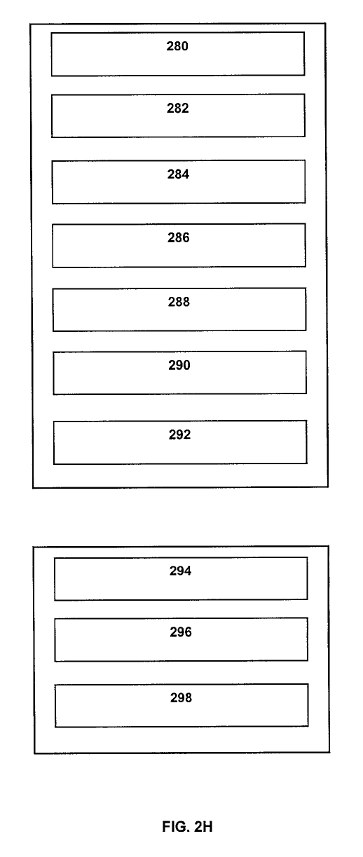

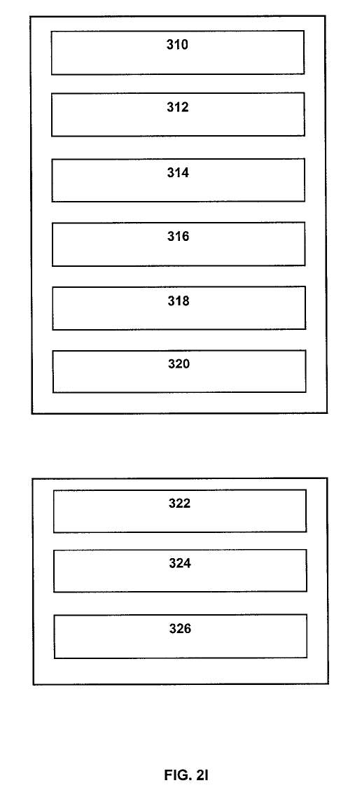

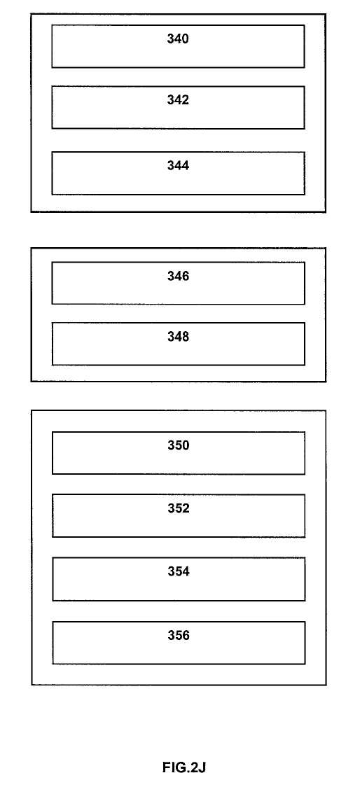

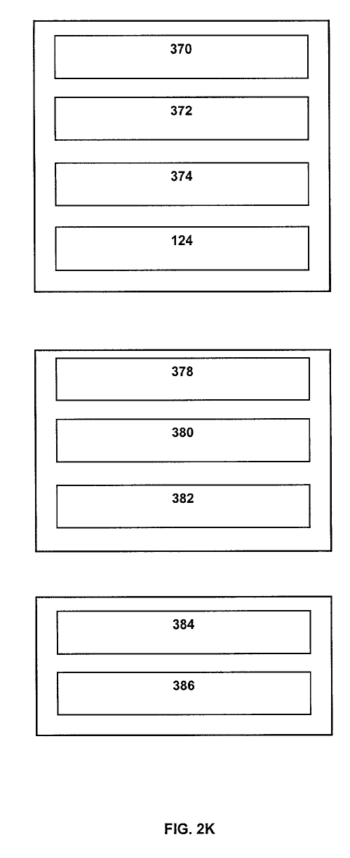

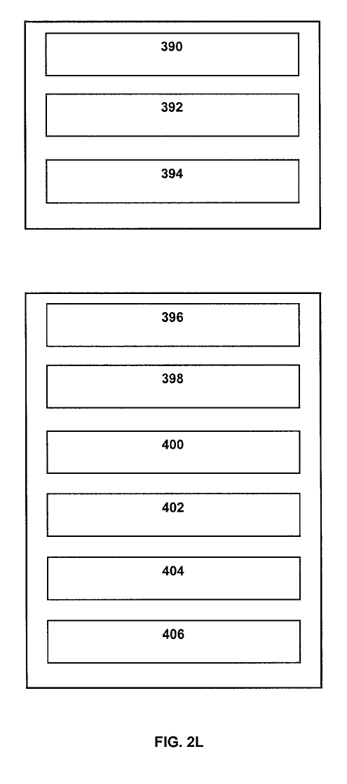

The invention, referring to FIGS. 1 and 2A through 2L, consists of twenty-four steps, as follows:

Step 1. Origination of Parties to the Transaction 100. The GTI System 50 begins after potential buyers and sellers, defined as end-users of the hosts interfaced with the MTL 10 (marketplace network client entity end-users 18, trade related marketmaker member end-users 22 and corporate entity end-users 26), “discover” each other within the host's marketing environment, by way of online directory searches, posted trade leads and opportunities, chat rooms, posting boards, virtual trade shows, banner advertisements, or other means. The process of the invention begins at the point that a potential buyer and seller agree to use the GTI System 50, and decide to enter the GTI System 50 through interfaces constructed between a host and the MTL 10.

At this point of interface with a host, the GTI System 50 creates a registration process for the buyer and the seller, establishing unique usernames and passwords for each party 102 in a 100% encrypted, secure electronic environment 104. This encrypted environment will be carried through for the remainder of the transaction. Basic contact information is then entered into GTI System databases in two ways: through a GUI by the buyer and the seller 106 as guided by system prompts and/or through an Application Programming Interface (“API”) with the Host 108. Buyers and sellers are prompted by the GTI System 50 to select a major world language “language template” 110, which will automatically display all GUI heading, help and system prompt text to the user in the selected language for the remainder of the transaction process.

The GTI System 50 creates a transaction-reporting template for the host 112. This template will collect selected subsequent buyer/seller activity related directly to the immediate transaction, which the host may access through the established interface.

Step 2. Creation of a Meeting Room 120 The GTI System 50 creates a private, unique electronic “meeting room” template for the potential buyer and seller to use to create a request for quotation. All electronic meeting rooms 120 contain the following features, and these features are contained in all subsequent templates created by the GTI System 50, and are available to both the buyer and seller for the remainder of the transaction:

Potential buyers and sellers may communicate with each other through a private threaded discussion application commonly termed an electronic “bulletin board”, through a real time messaging application commonly termed a “chat room”, or through an internal e-mail system, which allows both text and image attachments 122.

The GTI System 50 creates personal electronic “filing cabinets” 124 for both the potential buyer and seller. These filing cabinets 124 automatically store all communications related to the transaction created by the buyer, seller, GTI System 50 and third party service providers, and reside within the GTI System 50 computer servers.

The GTI System 50 creates access to a credit card facility 126, which is designed to process all credit card payments by a buyer or seller to the GTI System 50 or to a third party service provider. This facility, with the GTI System 50 as the designated merchant, is linked to a credit card payment processing vendor through an API, which in turn is linked to various major international credit card providers.

Buyers and sellers are provided access various international trade-related third party service providers, which are integrated with the GTI System 50 through the GUI and API and terminate in a third party provider interface 128. These service providers are identified and selected by GTI System operators, who contract for, and manage, their services on behalf of potential buyers and sellers. These services may be accessed and used separately by buyers and sellers, and are used throughout the transaction process by the GTI System 50 on behalf of the buyers and sellers as required. The services of the third party service providers include: translation services, business verification services, credit and business reporting services, cargo and risk insurance services, merchandise and documentation inspection services, air courier services, credit insurance and credit rating services, product marketing reportage services, international product specification standards consulting services, international freight forwarding services, customs brokerage services, international tariff duty and tax rate services and international chambers of commerce certification and verification services.

The GTI System 50 provides access to databases of international trade-related information 130, which are stored within the GTI System computer servers. Potential buyers and sellers may access and search this information at any time during a transaction. These databases contain: country-specific business and cultural information, product and industry information, the Harmonized System of Classification product codes, the Standard Industrial Codes, country-specific regulatory information, country-specific documentation libraries and hyperlinks to external informational databases containing trade regulations, trade process knowledge, and regulatory agencies and international standards bodies.

The GTI System 50 provides access to help information through the on-line help interface 132. This information includes assistance to potential buyers and sellers, as well as third party service providers and intermediary hosts, on the GTI System 50 process and on the process of international trade. This feature incorporates an e-mail response application to further assist all buyers and sellers with GTI System 50 specific difficulties, and is monitored by GTI System operators.

The GTI System 50 includes a banner advertising application 134, from which GTI System operators may solicit and display advertising and promotional content to potential buyers and sellers utilizing the GUI throughout the transaction process.

Step 3. Request for Quotation 140 This is an iterative process that allows potential buyers and sellers to communicate with each other, within a meeting room, utilizing the communications tools provided by the GTI System 50. Activities may include corresponding with each other via e-mail, discussion and chat rooms; sending product specifications, descriptions and brochures, and asking and answering product-related queries. Integrated third party service provider interfaces 128 allow the buyers and sellers access to participating air couriers 142 and inspection services 144 in order to facilitate the shipment of product samples, and for potential sellers to charge potential buyers for such samples by using the GTI System's credit card processing facilities 126. An interface to an online translation service provider 148 provides for the translations of key documents and communications for both parties to the transaction, and this service would be processed through the GTI System credit card processing facility 126.

The request for quotation step 140 results in the decision either of the parties not to proceed, or to the decision by both parties to proceed with the transaction. This decision to proceed is expressed by the potential buyer in a document created by the GTI System 50 and termed the “Request for Quotation” 150. Upon electronic acceptance of this document by the potential seller, termed an “invitation”, the parties proceed to the next step of the transaction in the pro forma stage of the GTI System 50 process.

Step 4. Creation of a Trading Room 160 Upon acceptance of both parties to continue the process and to create and negotiate a quotation, termed a “pro forma invoice”, one or both of the parties will pay a transaction fee to the GTI System operators, through the GTI System credit card processing facility 126. Upon payment of the transaction fee, the GTI System 50 creates a private, unique electronic trading room 160, which the GTI System 50 will generate from the meeting room template, retaining all the features offered by the meeting room 120. The purpose of the trading room 160 is to create a transaction template that will guide the buyer and seller to mutually create a pro forma invoice 162 acceptable to both parties. The transaction template will define all elements of the proposed transaction, itemize all associated costs of the proposed transaction, and facilitate assignment of all the responsibilities of the parties to the transaction, resulting in complete terms of sale, a specific Incoterm as defined by the International Chamber of Commerce publication “Incoterms 2000”, and complete terms of payment. The transaction template creates a rational environment in which parties may negotiate the components of the transaction to their satisfaction.

As an alternative, the parties may mutually select and agree to a specific Incoterm to guide the terms of sale. In this case, the GTI System 50 creates an Incoterm transaction template 164 that will guide the pro forma process to the criteria as specified by the selected Incoterm.

Step 5. Identification of Parties 170 The GTI System 50 prompts and guides buyers and sellers, through the GUI, for further company and individual information regarding both parties (i.e. company address, contacts, unique international corporate identification code, corporate credit card, bank, government exporter or importer identification number, e-mail address etc), which the GTI System 50 collects and compiles into appropriate databases stored within the GTI System computer servers 172. A D-U-N-S (“D-U-N-S” is a registered trademark of Dun & Bradstreet Incorporated) number is the preferred international corporate identifier and if no D-U-N-S number is available for a party, then that party is guided by a GTI system application to acquire one by utilizing an integrated interface to the Dun & Bradstreet Corporation 174. The GTI System 50 checks the D-U-N-S number of each party to verify the existence of the business entity, and displays both Dun & Bradstreet (“Dun & Bradstreet” is a registered trademark of Dun & Bradstreet Incorporated) verification records to each party. 176. The GTI System 50 determines the appropriate International Standards Organization (“ISO”) country code of the seller's country of export and the buyer's country of ultimate import, and stores this information in the appropriate database 178. In addition, the GTI System 50 communicates with both the buying and selling companies by Internet fax and e-mail, and checks that the individuals involved in the transaction are agents/employees of the respective buyer and seller, and that they have the authority to represent their firms in the transaction 180.

Step 6. Verification and Credit Review of the Parties 182 At this step, both parties to the transaction are given the option to access third party service providers, which are integrated with the GTI System 50 through interfaces, to further verify each other. These third party service providers may be engaged at this, or any other, point in the pro forma stage, and include business verification and on-site inspection services 184, business credit reporting services 186, business credit rating services 188 and business reference checks and confirmations by local chambers of commerce 190. The inquiring party pays for the costs of additional verifications by credit card, utilizing the GTI System credit card payment facility 126.

Step 7. Description and Classification of the Products 200 The GTI System 50 prompts and guides the parties to enter into the transaction template, through the GUI, a full and complete commercial description of the merchandise to be traded, including the appropriate units of measure, the quantities to be shipped, and the country or countries of origin of the goods 202. This information is initially copied from the buyer's request for quotation 140, and is modified as required by the seller. Buyers and sellers are prompted and guided to enter accurate and correct country of origin information by the GTI System 50, which utilizes business logic applications stored within the MTL 10 and informational databases stored within the GTI System computer servers 204.

The GTI System 50 then guides and prompts the parties to select a 6-digit Harmonized System of Classification (“HS”) commodity number for each product, using a GTI System application, which allows buyers and sellers to search through the HS commodity classification descriptions 206. The GTI System 50 adds each selected HS commodity code, description and unit of measure to the appropriate product line item in the transaction template.

The GTI System 50 prompts and guides the buyer to enter into the transaction template, through the GUI, any desired and/or required product modifications, customizations, labeling and packaging requirements 208. Buyer and seller are prompted and guided to enter any additional costs that may arise from accepting these modifications, and are prompted and guided to assign responsibilities for these compliance measures and costs. The GTI System 50 offers an application, utilized and viewed only by the seller, which facilitates the determination of the seller's standard cost of goods sold and per item, and computes gross margins per various proposed selling prices per item 210. Based on any additional product modification costs, and the seller's cost of goods as viewed only by the seller, the seller enters per-unit selling prices into the transaction template, as well as the earliest possible shipping date of the products 212.

Since proper and accurate product classification under the HS is critical to the export/import process, the GTI System 50 causes all product classifications by buyers and sellers to be reviewed by contracted International Freight Forwarder (“IFF”) and/or Custom House Brokerage (“CHB”) third party service providers, through an integrated interface 214. The third party service provider flags misclassifications and potential errors, and the GTI System 50 manages both the seller and the third party service provider until an HS commodity code has been entered into the transaction template that has been verified by the third party service provider.

Step 8. Regulatory Review of Parties and Countries of Origin and Destination 216 At this step, the GTI System 50 reviews the buyer, the seller and the countries of shipment and ultimate destination, per the HS product classifications of the merchandise intended for shipment, for government regulatory denials, restrictions and bans. The GTI System 50 utilizes the business logic of the MTL 10 and various regulatory database tables stored within the GTI System 50 computer servers to conduct this review 218, and then uses the contracted services of an IFF and/or CHB third party service provider to review and verify the results, through established compliance review interfaces with the GTI System 220. The GTI System 50 flags all errors and potential compliance problems to both parties, and manages the buyer, seller and the third party service provider until the information pertaining to appropriate regulatory compliance has been entered into the transaction template and confirmed by the third party service provider 222.

Step 9. Regulatory Review of Products 230 Based on the countries of export and import and the Harmonized classification of the product(s) as entered into the transaction template, the GTI System 50 reviews the products for any specific government regulatory requirements pertaining to labeling/packaging, product certifications, pre-shipment inspections, origin certifications, import licenses/quotas, hazmat labeling/packaging, declarations, export licensing/restrictions, and country/region/international standards. The GTI System 50 utilizes the business logic of the MTL 10 and various regulatory database tables stored within the GTI System 50 computer servers to conduct this review 218, and then uses the contracted services of an IFF and/or CHB third party service provider to review, amplify and verify the results, through established compliance review interfaces 220 within the GTI System 50.

The GTI System 50 flags all errors and potential compliance problems to both parties, and identifies all additional compliance measures which must be taken by the parties 222. It manages the buyer, seller and the third party service provider until the information pertaining to for appropriate regulatory compliance has been entered into the transaction template and confirmed by the third party service provider. The GTI System 50 identifies all required additional compliance activities, such as product marking or additional declarations or certifications, facilitates allocating the responsibilities for each activity to either the buyer or seller, and captures and itemized any additional costs associated with each compliance activity.

Note: Steps 10, 11 and 12 (Logistics). In the three logistics phases, Steps 10, 11 and 12, the buyer and seller are prompted by the GTI System 50 to make selections in three logistical areas, to define costs and to assign responsibilities between each other. The GTI System 50 contracts professional service providers, chiefly IFF and CHB, to secure and manage many of the logistics services used by buyers and sellers in the logistics steps. The IFFs and CHBs communicate with the GTI System through APIs and GUIs. Other service providers, in turn contracted and managed by the IFFs and CHBs, communicate with the GTI System 50 through these two service providers.

The GTI System 50 allows the buyer and seller to opt to have an integrated IFF/CHB issue quotations for all elements of the Logistics Steps, dividing the cost and responsibilities between them, or they may elect to utilize separate integrated third party service providers for certain elements of the Logistics Steps, leaving the balance of the elements to the integrated IFF/CHB.

Step 10. Logistics: Mode and Method of Main Carriage 238 The GTI System 50 prompts and guides the buyer and seller to select an IFF and/or CHB that has been contracted by the GTI System operators and that has been connected to the IFF/CHB interface 240. The GTI System 50 facilitates compliance with the requirement that buyers, as importers, and sellers, as exporters, complete powers of attorney documents for the IFF and CHB selected.

The GTI System 50 then guides and prompts the buyer and seller to determine the method and mode of carriage which will transport the goods from the point of origin to the port of embarkation, then to the port of debarkation, and finally to the ultimate destination. This process includes selecting the mode(s) of shipment (air, ocean, rail, motor, or intermodal), the route and the identification of the specific carriers, and determines the responsibilities for payment of main and inland carriage. Quotations are requested and received for all carriage services through integrated IFF and/CHB 242. The GTI System 50 restricts buyer and user selection of specific carriers outside of the IFF/CHB interface 240, with the exception of carriage by air courier, which they may select as an additional integrated third party service provider from within the cost allocation interface 244.

The GTI System 50 prompts and guides buyers, sellers and third party service providers to enter all services, quoted service fees, quoted service costs, and to identify the respective responsible parties into the transaction template through the cost allocation interface 244. The GTI System 50 checks that all information has been received and approved by the parties, and issues system notifications and alerts until such information is complete.

Step 11. Logistics: Commercial Requirements 250 The GTI System 50 assists the buyer and seller in determining the commercial requirements of the transaction through the MTL 10 business rules and through the integrated third party service provider IFFs and/or CHBs contracted for the transaction. These commercial components include: cargo insurance, through the IFF/CHB or from another third party service provider 252; pre-shipment inspection, if required, from another third party service provider 254; international standards certification, from yet another third party service provider 256; miscellaneous services, such as special warehouse and storage services and miscellaneous transport services, through the IFF/CHB 258; and commercial documentation preparation, through the IFF/CHB or from another third party service provider 260.

The GTI System 50 prompts and guides buyers, sellers and third party service providers to enter all services, quoted service fees, quoted service costs, and to identify the respective responsible parties into the transaction template through the cost allocation interface 244. The GTI System 50 checks that all information has been received and approved by the parties, and issues system notifications and alerts until such information is complete.

Step 12. Logistics: Regulatory Requirements 264 The GTI System 50 utilizes the IFFs and/or CHBs, as contracted for the transaction, as the exclusive agents to process and ensure compliance with all regulatory requirements. The IFF/CHBs create, acquire, and file the relavent information with the appropriate regulatory authorities, and the are responsible to the GTI System 50 of entering this information into the transaction template. All estimated elements, estimated costs and estimated fees are determined and introduced into the export transaction template 266 for export-related requirements, including export declarations, clearance, controls, and taxes, and import-related requirements are introduced into the import transaction template 268, including customs entry, declarations, inspection, clearance, customs bonds, duties, and taxes. Miscellaneous government agency declarations, inspections, certification, and fee requirements are separated into either export-related or import-related requirements.

The GTI System 50 prompts and guides buyers, sellers and third party service providers to enter all regulatory fees and taxes, quoted service fees, quoted service costs, and to identify the respective responsible parties into the transaction template through the cost allocation interface 244. The GTI System 50 checks that all information has been received and approved by the parties, and issues system notifications and alerts until such information is complete.

Step 13. Terms of Payment 280 The GTI System 50 guides and prompts the buyer and seller to determine terms and method of payment and collection for the proposed transaction. Options will depend on the size of the transaction, the countries involved, and the degree of trust that has been established between the parties. At this point, the parties may return to the Verification of Parties 182 stage and conduct further business credit checks, verifications, and reference checks.

The GTI System 50 facilitates six basic methods of payment and collection, many utilizing the integrated services of third party service providers. For each method utilized by the parties, the GTI System 50 prompts the parties to enter all process costs and expenses, and to identify the party responsible for each. Payment and collection options include open account terms, net xx days, dependent upon documentary evidence of shipment, using documents stored and/or generated by the GTI System 50, and payable in a defined currency 282; major credit card payment, upon documentary evidence of shipment and receipt of the merchandise, and processed through the third party credit card interface 284 through an integrated third party service provider; open account terms 286, net xx days, dependent upon documentary evidence of shipment, and backed by credit insurance as issued by an integrated third party service provider; a pre-paid escrow arrangement 288, using an integrated escrow service provider and documentary evidence of shipment; a acceptance draft program 290, through the issuance of bankers' acceptances or trade acceptances, as provided by an integrated third party provider; and through a documentary letter of credit facility, processed partially on-line and partially off-line, as controlled and monitored by the letter of credit interface 292.

Step 14. Terms of Sale 294 At this stage in the transaction, the GTI System 50 has introduced into the pro forma invoice template all pertinent and required elements of the transaction, and has assigned each one as the responsibility of the buyer, the seller or an integrated third party service provider. All quoted prices for services are dated, as are all proposed elements of the transaction. The GTI System 50 date-checks these elements for inconsistencies (i.e. export packing date after the forwarder's pick-up date), and notifies the parties if there are any inconsistencies or omissions. The GTI System 50 reviews the pro forma invoice for the assignment of responsibilities of all major elements, and displays the appropriate Incoterm that describe the transaction's terms of sale 296. If the buyer and seller had selected an Incoterm at the beginning of the process 264, then the GTI System 50 reviews the transaction template for inconsistencies, and notifies the buyer and seller 298. Buyers and sellers may also introduce an alternate Incoterm in order to see the affect it would have on the transaction template; the GTI System 50 responds with the notification of any inconsistencies between the Incoterm's requirements and the information contained in the transaction template.

Step 15. Negotiating the Pro Forma Invoice 310 After the Terms of Sale have been determined, and the GTI System 50 has confirmed that the transaction contains no errors or inconsistencies, a draft pro forma invoice is displayed to both the buyer and seller 312. The GTI System 50 now displays a draft gross margin summary, separately, to both the buyer and seller. The buyer reviews an itemization of the total transaction elements and costs for which she/he has been assigned within the transaction template, expressed as the total landed cost for the delivered goods. The buyer may utilize a GTI System application that allows the entry of proposed resale prices to compute gross profit margins, or may enter the cost of goods for domestic equivalents to the proposed transaction 314. The seller reviews an itemization of the total transaction elements and costs for which he/she has been assigned within the transaction template, expressed as the total cost for the sale of the goods and which includes the gross profit margin of the proposed sale. The seller may utilize a GTI System application, which allows the entry of alternate per-unit selling prices to compute alternate gross profit margins 316.

The GTI System 50 now allows both the seller and buyer to negotiate the terms of sale and payment as defined within the draft pro forma invoice. Either party may propose changes to pricing, cost allocation and responsibility, and may explore the employment of alternate third party service provider integrated services by requesting additional or alternate quotations from these providers 318. After each set of changes to the draft pro forma invoice, the GTI System 50 reviews the transaction template for errors, omissions and inconsistencies, notifying all parties accordingly.

Upon completion of an iterative negotiation process of the draft pro forma invoice by the seller and buyer, the GTI System 50 confirms this document as a complete, valid pro forma invoice quotation on the part of the seller, allowing no further changes by either party, and prompts the seller for an electronic signature to verify his/her acceptance 318. The resultant pro forma invoice is archived within the GTI System 50 in a locked portable document format file.

Step 16. International Sales Order 322 When the seller notifies the GTI System 50 that he/she accepts the terms of the pro forma invoice, the GTI System 50 prompts the buyer for acceptance of the pro forma invoice. Upon acceptance by the buyer, the GTI System 50 creates an international sales order document from the pro forma invoice template, and verifies the buyer's acceptance of the international sales order by requiring the electronic signature of the buyer 324. The GTI System 50 prompts the seller to confirm the acceptance of the International Sales Order by verifying this acceptance with an electronic signature on an order acceptance document 326. Both documents are archived within the GTI System in locked portable document format files. The detailed pro forma invoice may also be used by the buyer in seeking financing for the imported merchandise, or to satisfy domestic quota and other regulatory requirements. The international sales order may also be used by the seller in seeking working capital financing to manufacture or acquire the products to be sold to the buyer.

Step 17. Commercial Invoice 340 Upon acceptance of the international sales order by the seller, the GTI System 50 creates a commercial invoice template from the pro forma invoice 342. The commercial invoice template is used to track the completion of all subsequent events of the transaction, and prompts all parties to the transaction for the input of performance dates and actual versus estimated service costs. At the end of the GTI transaction process, the GTI System 50 creates a commercial invoice document to memorialize all actual events and costs related to the transaction.

Step 18. Integrated Third Party Service Providers 346 Upon the creation of the commercial invoice template, the GTI System 50 prompts the buyer and seller to accept the quotations for services to be performed by the integrated third party service providers as identified in the pro forma invoice steps of the transaction. These acceptances are noted in the transaction template by the GTI System 50, are documented in third party service provider electronic contracts created by buyers and sellers through GTI System 50, and are then distributed by the GTI System 50 and stored in the appropriate buyer or seller personal electronic file cabinets 348.

Some documents, such as power of attorney authorizations required by CHBs, IFFs, and some bills of lading, must be signed by the buyer and/or seller and faxed to the service provider. The GTI System 50 facilitates this process using electronic signatures and Internet fax applications. Other documents related to integrated third party service providers and their sub-contracted service agents might be hand-signed paper documents and contracts, which do not exist in electronic form. For this category of documents, integrated third party service providers are responsible for scanning such non-electronic documents into portable document format files, and entering them into the GTI System 50.

Step 19. Transaction Monitoring and System Notification 350 As the various transactional elements are completed, and the commercial invoice transaction template is updated, the GTI System 50 informs all parties to the transaction, including integrated third party service providers, of key upcoming dates, changes, and problems. System notifications 352 are sent by the GTI System 50 through messages posted to the commercial invoice template and through e-mail messages to the buyer, seller and integrated third party service providers. Third party service provider notifications 354, consisting of cost quotations, performance dates, and logistic element identification, are sent by e-mail messages to the buyer and/or seller, and are entered into the commercial invoice template through the GUI or API. System alerts 356, which notify all parties to the transaction of problems that require immediate action, are delivered by the GTI System 50 to the buyer/seller trading room, the commercial invoice template, to all parties via e-mail messages, and to the integrated third party service providers through the GUI and/or API.

Step 20. Transaction Documentation Creation, Acquisition, and Storage 370 The GTI System 50 creates key commercial documentation from data entered during the pro forma invoice and the commercial invoice stages. These documents include the commercial invoice, customs invoices, origin certifications, packing lists, and various declarations 372. Non-system created documents 374 originating from integrated third party service providers, or their sub-contractors, or their regulatory agency clients, and which are not initially resident within the GTI System 50, are transmitted into the GTI System 50 in electronic file format or, if not in electronic form, are scanned and converted to portable document format files and then transmitted to the GTI System 50.

The GTI System 50 stores all documents related to a transaction in transaction-specific files, in GTI System archive files, in third party service provider files, and in the buyer and seller personal electronic file cabinets 124.

Step 21. Regulatory Reporting and Compliance 378 Regulatory filings and declarations, as required by specific country export/import related agencies, are exclusively performed by the licensed in-country GTI System third party service provider, either manually with paper documentation or electronically using such applications as the Automated Broker Interface (“ABI”) and Automated Export System (“AES”) in the United States. The GTI System 50 monitors the compliance of all regulatory requirements and the performance of the third party service providers In all events, electronic copies of all original regulatory documents will be converted to locked portable document format files, cross-referenced to the transaction for which they were created and to the parties to the transaction, and stored within secure regulatory document files within the GTI system 50, for time periods as specified by the laws of the countries of import and export 382.

Step 22. Payment and Collection Process Management 384 Upon the receipt of notification of clearance of the merchandise into the country of destination, or delivery of the goods, or other agreed-upon event, the GTI System 50 notifies the parties and payment service providers to begin the payment/collection process as negotiated in the payment terms of the pro forma stage. The GTI System 50 distributes key documents, such as the commercial invoice, to the recipient third party service providers, as per the agreed method of payment, through their document distribution interface 386. Third party service providers utilize their GTI System 50 interface to enter payment process events and dates into the commercial invoice template, and the buyers and sellers access these third party service providers through the transaction template. Some payment options, such as confirmed letters of credit, utilize the transaction template to record key events and dates of the payment process only. Original documents, as required by third party payment/collection providers (banks, agents) are distributed by GTI System 50 as required to support collection activities.

Step 23. User Information Archives 390 Both buyer and seller may store the completed transaction in their personal files in the user data archives 392. The documents associated with any transaction, such as product catalogs or product specifications, may be stored within, and accessed from, a personal file archive 394 as well. Buyers and sellers may use a an electronic “copy” of an entire Pro Forma Invoice template to create and process subsequent transactions, thus reducing the time and effort required for future transactions with each other. Buyers and sellers may also use an electronic “copy” of a transaction template as the basis for new transactions with other potential buyers or sellers, thus making new transactions with new partners quicker, easier, and more successful.

Step 24. System Information Archives 396 The GTI System 50 archives all transactions in the transaction template archive 398, whether they are completed or not. All regulatory-related documents are cross-referenced and stored as locked portable document format files in a regulatory file archive 400. This serves as an audit trail for regulatory compliance, if required, by any customs agency. Archived template data are also utilized by the GTI System 50 as the basis for transaction an activity reporting for intermediary hosts 402, integrated third party service providers 404 and credit card payment service providers 406.

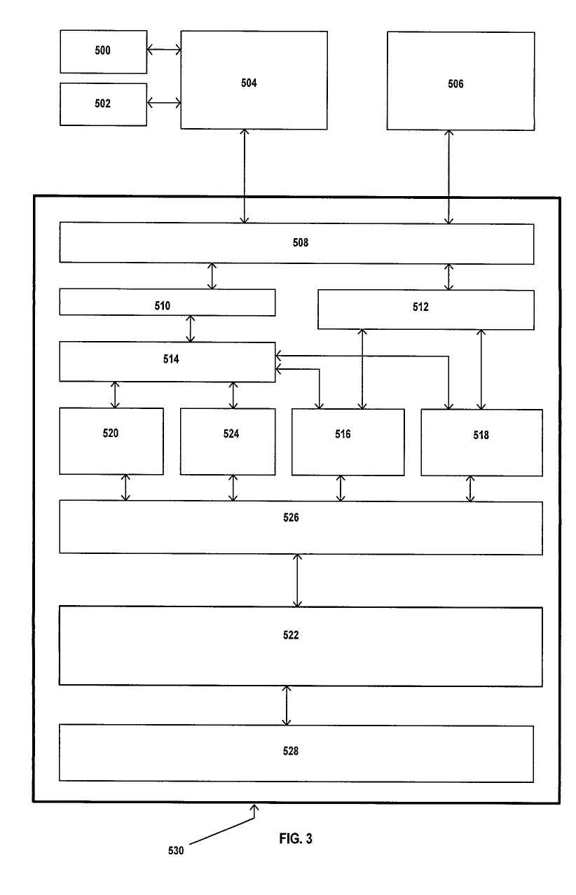

Another embodiment of the invention is shown in FIG. 3, which describes a preferred technological architecture that the inventors consider the best mode of the subject invention.

A potential buyer 500 and seller 502 meet within an intermediary host's 504 marketing environment, and access the GTI System 530 through a GUI from the intermediary host's marketplace platform.

An intermediary host 504 creates marketplaces for clients and re-sells the services of the GTI System 530. The host 504 delivers prospective buyers 500 and sellers 502 to a unique web tier interface 514, which is personalized in design to the intermediary host's marketplace, through a secure GUI 510, and connect to the intermediary host management application 516 through either a secure GUI 510 or a secure API 512. Buyers and sellers work within the environment of the web tier interface 514 throughout the GTI System process. Intermediary hosts receive and monitor transaction reports of their members' activities through intermediary host management application 516.

Third party service providers 506 connect to the GTI System 530 primarily through a secure API 512 to communicate with the third party management module 518, but may also connect to the GTI System 530 through a secure GUI 510.

All Interfaces with entities external to the GTI System 530 pass through an encryption/decryption module 508. Using the most current security protocols, this provides security for the data being transmitted amongst all the transacting parties.

Buyers 500 and sellers 502 communicate with the GTI System 530 utilizing the secure GUI 510 and the web tier interface 514. Intermediary hosts 504 and third party service providers 506 may, in some instances, utilize the secure GUI 510 as well.

Data streams transmitted through the secure API 512, and processed by either the intermediary host management module 516 or the third party service provider management module 518, enable intermediary hosts 504 and third party service providers 506 to communicate with the GTI System 530.

A web tier 514 enables buyers 500, sellers 502, intermediary hosts 504 and third party service providers 506 to interact with the GTI System 530. This web tier 514 contains personalized intermediary host 504 GUI web pages, Internet communication applications (e.g. e-mail, chat room, discussion board), an advertising management module, and various Internet web applications and operating programs. The web tier displays information to all users per the content and personalization management module 520.

An intermediary host management module 516 controls access of intermediary hosts 504 to the GTI System 530, and allows the GTI System 530 to communicate with intermediary hosts 504, to deliver intermediary host's 504 member transaction reports, and to transfer intermediary host's 504 member information to the GTI System 530, chiefly through a secure API 512.

Third party service provider management modules 518 control access of third party service providers 506 to the GTI System 530, and control communications between the third party service providers 506 and the GTI System 530. Interfaces, chiefly through the secure API 512, are designed in a modular fashion, allowing the addition or elimination of third party service providers contracted to the GTI System 530 quickly and efficiently.

A content and personalization management module 520 controls the format and display of information to buyers 500, sellers 502, intermediary hosts 504 and third party service providers 506 through the web tier 514 by the GTI System 530, and serves the work flow engine within the MTL 522.

A buyer/seller management module 524 controls buyer 500 and seller 502 access and contact information, controls the registration and log-in process of buyers 500 and sellers 502, and serves the work flow engine within the MTL 522.

The MTL 522 contains the business rules processor, the GTI System 530 workflow engine, and an event sequencer. It operates with, and coordinates the flow of all information to, the other management modules through a data exchange platform 526. The MTL 522 manages database search routines conducted in the various databases maintained within the database management system 528.

A data exchange module 526 is an e-commerce application platform that serves to translate and distribute information in XML, or another suitable data exchange syntax, format between the MTL 522 work flow engine, all other management modules of the GTI System 530, and intermediary hosts 506 and third party service providers 504 who connect to the GTI System 530 through a secure API interface 512.

A data base management system (“DBMS”) 528 controls the various databases of information utilized by the GTI System 530, including trade information, transaction templates, business rules, buyer/seller activity and information, buyer/seller personal file cabinets, regulatory documents, intermediary host activity and reports, third party service provider activity and reports, GTI System tracking logs and all archived information. The DBMS 528 stores information in structured database files, portable document format files, electronic image files, and ASCII text files.

While the invention has been described with respect to a preferred embodiment, it is apparent that various changes can be made without departing from the scope of the invention. Also, it will be seen to be within the purview of those of skill in the art, in the light of the inventive combinations of components and steps detailed in the description, to readily select, obtain, produce, and assemble the hardware, software, and service elements for achieving various systems suitable for functioning in accordance with and within the scope of the invention.

What is claimed is:

1. A computer-implemented transaction management system for guiding a buyer and seller through the complete export/import trade process to achieve single cross-border merchandise trade transactions between the buyer and seller, and which system is fully integratable with the required third party service providers, comprising:
interface means, connected to the Internet, for enabling a buyer and seller to communicate with each other and with third party service providers on the Internet;
server means, connected to said interface means, for providing an application service provider environment capable of communication with said buyer and seller and with third party service providers on the Internet;
software applications, resident on said server means and created around an export/import trade business logic, for integrating and controlling said application service provider environment, and comprising:
means providing a pro forma template for guiding the buyer and seller to mutually create, in said application service provider environment, a pro forma quotation invoice which identifies cost elements, regulatory requirements, and third party service providers and their specific services to be rendered, and which enables the assignment of specific responsibilities to the buyer and seller;
means, using the created pro forma quotation invoice, for computing margin data for both the buyer and seller, and enabling a sub-process of iterative negotiations and changes to the pro forma quotation invoice to achieve a pro forma invoice acceptable to both the buyer and seller for a particular transaction;
means, using the acceptable pro forma invoice for the particular transaction, for enabling the buyer to create a purchase order for the seller and converting the pro forma template to a commercial invoice transaction template for the particular transaction;
means, using the commercial invoice transaction template, for enabling the buyer and seller to monitor and track the movement of the merchandise and the activities of the contracted third party service providers, and creating and/or acquiring, storing, and distributing information and documentation pertaining to the particular transaction to achieve its completion; and
means, responsive to achieving completion of the particular transaction, for storing and archiving said information pertaining to the particular transaction.

2. The system of claim 1, wherein said interface means comprise means for inputting information on the requirements of the buyer and the products offered by the seller to determine the existence of a supplier/purchaser relationship.

3. The system of claim 1, wherein said interface means comprise means for enabling the buyer to request a quotation from the seller for the seller to supply to the buyer specific merchandise, at a specific time and place, for a specific price.

4. A computer-implemented international trade method for managing, guiding and integrating the complete export/import trade process of single cross-border merchandise trade transactions on behalf of a buyer and seller, comprising the steps of:
providing an application service provider environment comprising the combination of Internet and computer server technology, and encryption and database software;
providing a series of software applications created around an export/import trade business logic for integrating and controlling said application service provider environment;
providing access for a buyer and seller to said application service provider environment through the Internet using personal computers and web browsers;
producing inputs from a buyer and seller through said remote personal computers and web browsers to said application service provider environment; and
completing, in response to said inputs from said buyer and seller, the export/import trade process of single cross-border merchandise trade transactions in said application service provider environment on behalf of said buyer and seller.

5. The method of claim 4, wherein said inputs comprise information on the requirements of the buyer and the products offered by the seller to determine the existence of a supplier/purchaser relationship.

6. The method of claim 4, wherein said inputs comprise the buyer's request for a quotation from the seller for the seller to supply to the buyer specific merchandise, at a specific time and place, for a specific price.

7. The method of claim 4, wherein said inputs comprise the seller providing the buyer with a quotation on a pro forma invoice containing the various details of an export/import transaction.

8. The method of claim 7, wherein said inputs comprise a negotiation exchange between the buyer and seller regarding the terms of sale, terms of delivery, and terms of payment expressed within the pro forma invoice.

9. The method of claim 8, wherein said inputs comprise, upon completion of the negotiation exchange and agreement on said terms, issuance by the buyer to the seller of a purchase order.

10. The method of claim 9, wherein said inputs comprise acceptance of the purchase order by the seller to begin the physical transaction process for obtaining buyer specific merchandise.

11. The method of claim 4, wherein said inputs comprise finalizing payment on the part of the buyer and collection on the part of the seller upon completion of an export/import trade process of single cross-border merchandise trade transaction.

12. A computer-implemented international trade system that manages, guides and integrates the complete export/import trade process of single cross-border merchandise trade transactions on behalf of a buyer and seller, comprising:
an application service provider environment comprising the combination of Internet and computer server technology components and encryption and database software;
a plurality of software applications created around an export/import trade business logic for integrating and controlling said application service provider environment;
access means for a buyer and seller to access said application service provider environment and provide inputs remotely using personal computers and web browsers; and
means, responsive to inputs from said buyer and seller through said access means, for completing the export/import trade process of single cross-border merchandise trade transactions in said application service provider environment on behalf of said buyer and seller.

13. The system of claim 12, wherein said access means comprise means for inputting information on the requirements of the buyer and the products offered by the seller to determine the existence of a supplier/purchaser relationship.

14. The system of claim 12, wherein said access means comprise means for enabling the buyer to input a request for a quotation from the seller for the seller to supply to the buyer specific merchandise, at a specific time and place, for a specific price.

15. The system of claim 12, wherein said access means comprise means for the seller to provide the buyer with a quotation in a pro forma invoice containing the various details of an export/import transaction.

16. The system of claim 15, wherein said access means comprise means for enabling a negotiation exchange between the buyer and seller regarding the terms of sale, terms of delivery, and terms of payment expressed within the pro forma invoice.

17. The system of claim 16, wherein said access means comprise means, responsive the agreement on said terms, for enabling the buyer to issue a purchase order to the seller.

18. The system of claim 12, wherein said software applications comprise means providing a pro forma template for guiding the buyer and seller to mutually create, in said application service provider environment, a pro forma quotation invoice which identifies cost elements, regulatory requirements, and third party service providers and their specific services to be rendered, and which enables the assignment of specific responsibilities to the buyer and seller.

19. The system of claim 18, wherein said software applications further comprise means, using the created pro forma quotation invoice, for computing margin data for both the buyer and seller, and enabling a sub-process of iterative negotiations and changes to the pro forma quotation invoice to achieve a pro forma invoice acceptable to both the buyer and seller for a particular transaction.

20. The system of claim 19, wherein said software applications further comprise:
means, using the acceptable pro forma invoice for the particular transaction, for enabling the buyer to create a purchase order for the seller and converting the pro forma template to a commercial invoice transaction template for the particular transaction; and
means, using the commercial invoice transaction template, for enabling the buyer and seller to monitor and track the movement of the merchandise and the activities of the contracted third party service providers, and creating and/or acquiring, storing, and distributing information and documentation pertaining to the particular transaction to achieve its completion.
